(19) United States
(12) Patent Application Publication
(10) Pub. No.: US 2017/0024734 A1
(43) Pub. Date: Jan. 26, 2017

(54) Systems and Methods for Processing Transactions to Payment Accounts

(71) Applicant: MASTERCARD INTERNATIONAL INCORPORATED, Purchase, NY (US)

(72) Inventors: Kenneth Unser, Fairfield, CT (US); Edward Lee, Scarsdale, NY (US)

(21) Appl. No.: 14/804,435

(22) Filed: Jul. 21, 2015

(51) Int. Cl. G06Q 20/40; G06Q 20/38

(52) U.S. Cl. CPC G06Q 20/401; G06Q 20/38

(57) ABSTRACT

Systems and methods are provided for processing transactions to payment accounts to add funds to the payment accounts. One exemplary method generally includes receiving, at a computing device, a transaction request for a transaction to a payment account where the transaction request includes a deposit identifier associated with the payment account but does not include a primary account number (PAN) for the payment account. The method also generally includes processing the transaction request to add funds to the payment account when the transaction includes a direction to add such funds to the payment account, and declining the transaction request when the transaction request includes a request to debit funds from the payment account.

### FIELD

The present disclosure generally relates to systems and methods for processing transactions to payment accounts. More particularly, the present disclosure relates to systems and methods for identifying and processing deposit transactions to the payment accounts, for example, for adding funds to, for making payments to, etc., the payment accounts.

### BACKGROUND

This section provides background information related to the present disclosure which is not necessarily prior art.

Consumers use payment accounts in transactions to purchase various products from merchants (e.g., goods and/or services, etc.). The payment accounts are typically provided to the consumers by issuers. And, the transactions involving the payment accounts are typically processed through payment networks such as, for example, MasterCard®, Visa®, etc. Payment accounts generally are issued in two types: credit accounts, by which the promise of payment is used to fund transactions, and debit accounts, by which moneys existing in the accounts are used to fund transactions. In connection with the debit accounts, consumers typically deposit the moneys into the accounts for subsequent use in the transactions.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in processing transactions to payment accounts including, for example, deposit transactions;

FIG. 2 is a block diagram of a computing device that may be used in the exemplary system of FIG. 1; and

FIG. 3 is an exemplary method that may be implemented in connection with the system of FIG. 1, for example, for identifying and processing a deposit transaction to a payment account associated with a consumer.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Consumers often use payment accounts in transactions both to fund purchases of products (e.g., goods and/or services, etc.) from merchants and to receive deposits from other individuals or other entities. Typically, payment accounts are associated with primary account numbers, which may be used to facilitate transfers of funds both into (e.g., as deposits, etc.) and out of (e.g., to fund purchases, etc.) the payment accounts. Because primary account numbers may be used to debit funds from accounts, they are often concealed or kept private to the consumers, and disseminated only to complete transactions, thereby limiting the risk of unauthorized transactions to the payment accounts. The systems and methods described herein can be used to implement unique account identifiers, different from the primary account numbers of the payment accounts, that can only be used to add funds to the payment accounts. As such, the consumers can provide the identifiers to the individuals (or other entities) to facilitate the deposit transactions, without concern that the identifiers would be used to facilitate unauthorized purchase transactions to (or withdrawals from) the payment accounts. Thus, the systems and methods herein provide a level of security to the consumers (who wish to provide deposit access to individuals (or entities) to their payment accounts) by providing the identifiers that are limited to deposit transactions, instead of the primary account numbers.

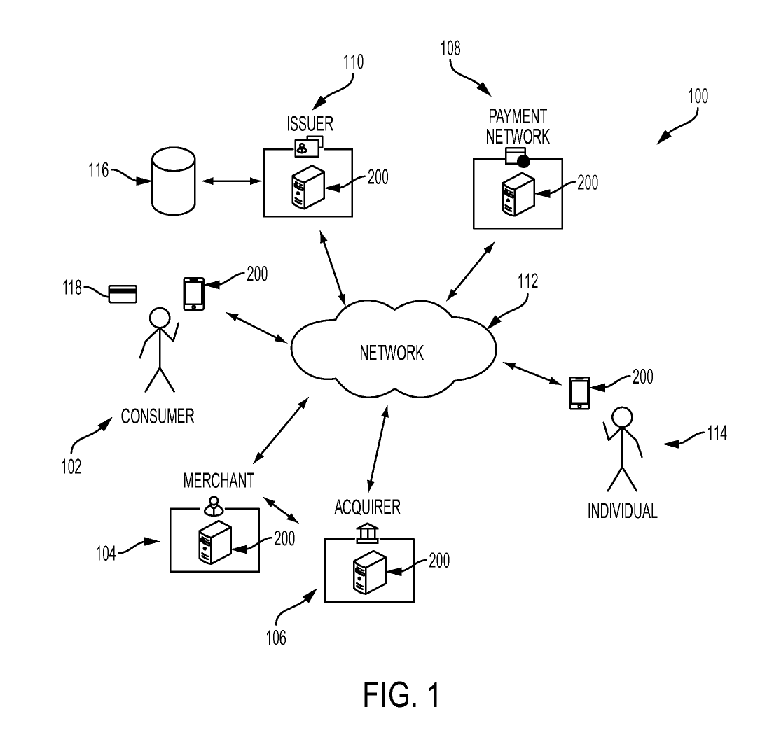

FIG. 1 illustrates an exemplary system 100 in which one or more aspects of the present disclosure may be implemented. Although components of the system 100 are presented in one arrangement, it should be appreciated that other exemplary embodiments may include the same or different components arranged otherwise, for example, depending on interactions and/or relationships between various components when processing transactions, etc.

The illustrated system 100 generally includes a consumer 102 (broadly, an account holder), a merchant 104, an acquirer 106 associated with the merchant 104, a payment network 108, and an issuer 110, each coupled to network 112. The network 112 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated components of the system 100, or any combination thereof. In one example, the network 112 includes multiple networks, where different ones of the multiple networks are accessible to different ones of the illustrated components in FIG. 1.

Typically in the system 100, the issuer 110 provides, or issues, a payment account to the consumer 102 that can be used by the consumer 102 in both purchase transactions (e.g., with the merchant 104, etc.) and deposit transactions (e.g., with the individual 114, with other entities, etc.). The issuer 110 may also associate a user profile with the payment account, when issued (or later), to provide general preferences, as requested or required by the consumer 102, for facilitating payments from and deposits to the payment account (e.g., notification preferences requesting emails to be sent to the consumer 102 when deposits are made to the payment account, etc.).

In connection with issuing the payment account to the consumer 102 in the system 100, the issuer 110 assigns both a primary account number (PAN) and a deposit identifier (e.g., a recipient identification, etc.) to the payment account. The PAN and the deposit identifier are then both stored by the issuer 110, in coordination with the consumer's payment account, in data structure 116 (e.g., via bank mapping by associating the deposit identifier to an interbank card association (ICA) number for the payment account, via payment account mapping by associating the deposit identifier directly to the PAN, etc.). In other exemplary embodiments, the issuer 110 may assign only the PAN, with another entity assigning the deposit identifier based on the PAN (or independent thereof) and then sharing the deposit identifier with the issuer 110, etc. In one such embodiment, the issuer 110 assigns the PAN to the payment account, and the payment network 108 assigns the deposit identifier. The payment network 108 then coordinates, and communicates, with the issuer 110, via the network 112, so that the deposit identifier is available to the issuer 110. In some aspects, this may include the payment network 108 directly communicating the deposit identifier to the issuer 110 so that the issuer 110 can associate it with the PAN for the payment account (in the data structure 116). In other aspects, the issuer 110 may communicate the PAN to the payment network 108 so that the payment network 108 can then associate the deposit identifier with the PAN for the payment account.

As an example, the issuer 110 may have (e.g., as provided by the payment network 108, etc.) a range of bank identification numbers (BINs), or a BIN range, that allocates a block of PANs to the issuer 110, one of which is then assigned by the issuer 110 to the consumer's payment account. Similarly, the issuer 110 may have a range of unique deposit identifiers (e.g., originating from the issuer 110, originating from the payment network 108, etc.), one of which is then also assigned to the consumer's payment account. Or, the deposit identifier may be from a listing of identifiers independently generated by the issuer 110, or by another entity. Further, the deposit identifier may be tied or translated to the PAN (e.g., based on the PAN, etc.), for example, based on a paired ordering of the deposit identifiers and PANs available to the issuer 110, based on an algorithm, etc., so that the issuer 110 (or other entity), later, can decode (or convert) the PAN from the deposit identifier (and vice versa). Or, the issuer 110 may assign a random deposit identifier to the PAN, from the pre-assigned range or not, so that there is no logical relationship between the deposit identifier and the PAN (e.g., such that the deposit identifier generally is not based on the PAN, etc.) (except for a correlation table of deposit identifiers to PANs stored in the data structure 116, etc.).

Once assigned to the consumer's payment account by the issuer 110, the PAN can be used in connection with both purchase transactions (e.g., at the merchant 104, etc.) where funds are withdrawn from (or drawn out of) the payment account, and deposit transactions (e.g., a payment from the individual 114 to the consumer 102, etc.) where funds are added to the payment account. Conversely, the deposit identifier assigned to the payment account can only be used to facilitate (e.g., can only serve as a basis for, etc.) deposit transactions to add funds to the payment account, and not purchase transactions. As such, the deposit identifier allows funds to be transmitted in only one direction to the payment account (i.e., as an addition into the payment account), as opposed to the PAN which allows funds to be transmitted in two directions (i.e., as an addition into the payment account and as a withdrawal out of the payment account).

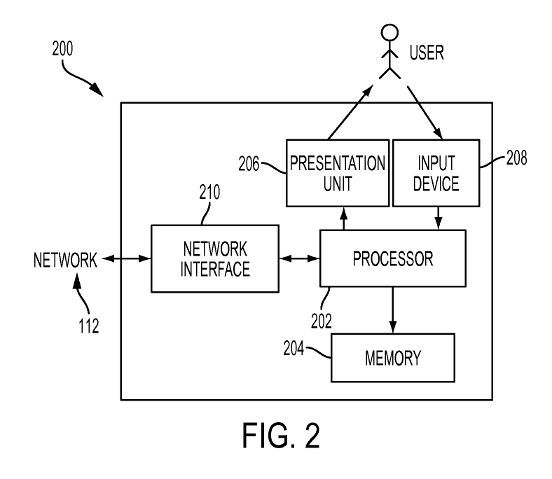

In the system 100, each of the consumer 102, the merchant 104, the acquirer 106, the payment network 108, the issuer 110, and the individual 114 is associated with, or implemented in, a computing device. For illustration, the system 100 is described with reference to exemplary computing device 200, illustrated in FIG. 2. And, each of the consumer 102, the merchant 104, the acquirer 106, the payment network 108, the issuer 110, and the individual 114 is associated with such a computing device 200. However, the system 100 and its components should not be considered limited to the computing device 200 of FIG. 2, as different computing devices and/or arrangements of computing devices may be used. In addition, different components and/or arrangements of components may be used in other computing devices. Further, in various exemplary embodiments, the computing device 200 may include multiple computing devices located in close proximity, or distributed over a geographic region (such that each computing device 200 in the system 100 may represent multiple computing devices, etc.). Additionally, each computing device 200 illustrated in the system 100 may be coupled to a network (e.g., the Internet, an intranet, a private or public LAN, WAN, mobile network, telecommunication networks, combinations thereof, or other suitable network, etc.) that is either part of the network 112, or separate therefrom.

By way of example (and without limitation), each computing device 200 included in the system 100 may include one or more servers, workstations, personal computers, laptops, tablets, PDAs, telephones (e.g., cellular phones, smartphones, other phones, etc.), point of sale (POS) terminals, combinations thereof, etc., as appropriate.

As shown in FIG. 2, the exemplary computing device 200 generally includes a processor 202, and a memory 204 coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The processor 202 may be a single core processor, a multi-core processor, and/or multiple processors distributed within the computing device 200. The above examples are exemplary only, and are not intended to limit in any way the definition and/or meaning of processor.

The memory 204, as described herein, is one or more devices that enable information, such as executable instructions and/or other data, to be stored and retrieved. The memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, tapes, flash drives, hard disks, and/or any other type of volatile or nonvolatile physical or tangible computer-readable media. The memory 204 may be configured to store, without limitation, data relating to payment accounts including PANs and deposit identifiers, relationships between PANs for payment accounts and corresponding deposit identifiers (e.g., correlation tables, etc.), algorithms for relating deposit identifiers to particular PANs, user profiles, data for transactions processed to the payment accounts, and/or any other types of data suitable for use as described herein, etc.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

The illustrated computing device 200 also includes a presentation unit 206 that is coupled to the processor 202. The presentation unit 206 outputs, or presents, to a user (e.g., the consumer 102; individuals associated with one or more of the merchants 104, the acquirer 106, the payment network 108, and the issuer 110 in the system 100; the individual 114; etc.) by, for example, displaying, audibilizing, and/or otherwise outputting data such as, but not limited to, data relating to payment accounts, data relating to user profiles, data relating to relationships between PANs for payment accounts and corresponding deposit identifiers, data for transactions processed to the payment accounts, and/or any other type of data. It should be further appreciated that, in some embodiments, the presentation unit 206 comprises a display device such that various interfaces (e.g., applications, webpages, etc.) may be displayed at computing device 200, and in particular at the display device, to display such information and data, etc. And in some examples, the computing device 200 may cause the interfaces to be displayed at a display device of another computing device, including, for example, a server hosting a website having multiple webpages, etc. With that said, presentation unit 206 may include, without limitation, a liquid crystal display (LCD), a light-emitting diode (LED) display, an organic LED (OLED) display, an “electronic ink” display, speakers, combinations thereof, etc. In some embodiments, presentation unit 206 includes multiple units.

The computing device 200 further includes an input device 208 that receives input from the user. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in some exemplary embodiments, a touch screen, such as that included in a tablet, a smartphone, or similar device, behaves as both a presentation unit and an input device. In at least one exemplary embodiment, a presentation unit and/or an input device are omitted from a computing device.

In addition, the illustrated computing device 200 includes a network interface 210 coupled to the processor 202 (and, in some embodiments, to the memory 204 as well). The network interface 210 may include, without limitation, a wired network adapter, a wireless network adapter, a mobile telecommunications adapter, or other device capable of communicating to one or more different networks, including the network 112. In some exemplary embodiments, the computing device 200 includes the processor 202 and one or more network interfaces incorporated into or with the processor 202.

Referring again to FIG. 1, in one aspect of the system 100, the consumer 102 can initiate a purchase transaction at the merchant 104 for a desired product by presenting the PAN for the consumer's payment account to the merchant 104, for example, via payment device 118 (e.g., a payment card (e.g., a credit card, a debit card, etc.) or other device, etc.). In response, the merchant 104, the acquirer 106, the payment network 108, and the issuer 110 cooperate to authorize and clear the purchase transaction (e.g., using the MasterCard® interchange, etc.). For example, the merchant 104 communicates, via the acquirer 106, with the issuer 110, through the payment network 108 (e.g., using the MasterCard® interchange, etc.), for authorization for the purchase transaction. If the issuer 110 accepts the purchase transaction, an authorization response is provided back through the payment network 108 (and the acquirer 106) to the merchant 104. Upon authorization, the purchase transaction generally is completed. The balance (or credit) of the payment account used by the consumer 102 in the purchase transaction is altered (e.g., reduced, etc.) by the amount of the purchase transaction, and the transaction is posted to the consumer's payment account. The purchase transaction is later settled and cleared by and between the acquirer 106 and the issuer 110, directly or via the payment network 108.

In another aspect of the system 100, the consumer 102 can receive funds into the payment account (i.e., as a deposit transaction, etc.), for example, from the individual 114, through use of either the PAN or the deposit identifier. The deposit transaction may be directed (e.g., through a webpage, or directly at a brick-and-mortar location, etc.) to any one of the issuer 110, the payment network 108, the acquirer 106, and/or the merchant 104. Generally, the payment network 108 and the issuer 110 then cooperate, with the individual 114 or with a bank (or other issuer) associated with the individual 114, to authorize and clear the deposit transaction. Upon authorization, the deposit transaction generally is completed. The balance (or credit) of the payment account used by the consumer 102 in the transaction is altered (e.g., increased, etc.) by the amount of the deposit transaction (less any fees), and the transaction is posted to the consumer's payment account. The deposit transaction is later settled and cleared by and between the issuer 110 and the individual 114 (e.g., a bank (or other issuer) associated with the individual 114, etc.), the merchant 104, and the acquirer 106, as involved, directly or via the payment network 108.

The above deposit transaction may originate, from the individual 114, via an interface, for example, a web interface (e.g., a bill-pay interface, etc.) or other application (e.g., a mobile application available to the individual 114 on the individual's computing device 200, etc.) accessible by the individual 114 via the computing device 200 associated with the individual 114 and provided by the issuer 110, the payment network 108, the merchant 104, or another entity (e.g., a bank or other issuer associated with the individual 114, etc.), where the transaction is then processed through the payment network 108. Alternatively, the deposit transaction may originate from an interface accessible via a POS terminal provided by the merchant 104 (or other merchant), from a call or mail center, or directly at a brick-and-mortar location (e.g., directly at the issuer 110 such that the deposit transaction may be handled directly by the issuer 110, etc.), etc. In addition, the deposit transaction may include, or identify, any suitable funds to be transferred from the individual 114 to the consumer 102 (and added to the consumer's payment account) including, for example, cash, a check, an electronic transfer from a bank account or a credit/debit account, a payment from a prepaid card or from a gift card, a credit incentive from the merchant 104 (or another merchant) (e.g., get $10 off your next purchase, etc.), reward points (e.g., a transfer of mileage rewards to the payment account, etc.), etc.

Further, in both of the above purchase and deposit transactions, transaction data is generated as part of the various interactions between the consumer 102, the issuer 110, the payment network 108, the acquirer 106, the merchant 104, and the individual 114, as involved. The transaction data is stored in one or more different components of the system 100 (e.g., in memory of the computing device associated with the payment network 108, etc.). In addition, the transaction data can be transmitted between various entities of the system 100, via the network 112, as desired.

For the purchase transaction, the transaction data may include, without limitation, the PAN for the consumer's payment account, a payment amount for the product(s) involved in the transaction, identifier(s) for the product(s) involved in the transaction, description(s) of the product(s) involved in the transaction, a merchant name for the merchant 104 involved in the transaction, a merchant identification number (MID) for the merchant 104 involved in the transaction, a merchant category code (MCC) assigned to the merchant 104 involved in the transaction (e.g., by the payment network 108 or by another, based on a type of product(s) provided by the merchant 104, etc.), a date and/or time of the transaction, a location of the transaction, etc. For deposit transactions, the transaction data may include, without limitation, the PAN for the consumer's payment account, the deposit identifier for the consumer's payment account (in which case, the PAN may then not be included), an indicator that the transaction is for adding funds to the consumer's payment account, a deposit amount to be added to the consumer's payment account, a type of funds to be added to the consumer's payment account (e.g., a currency type, etc.), any restrictions to be associated with the funds added to the consumer's payment account (e.g., the funds can only be used at the merchant 104, etc.), an identity of the individual 114 or entity providing the funds, a date and/or time of the transaction, a location of the transaction, etc.

With that said, other transactions in the system 100 are processed in a similar manner. And, while only one consumer 102, one merchant 104, one acquirer 106, one payment network 108, one issuer 110, and one individual 114 are shown in the system 100 in FIG. 1, it should be appreciated that a different number of one or more of these entities may be included in other embodiments. In addition, while the above purchase and deposit transactions are described with reference to a particular routing of data through the system 100, it should be appreciated that the merchant 104, the acquirer 106, the payment network 108 and the issuer 110 may perform one or more functions differently, and may communicate directly or indirectly with each other or with other entities, in order to authorize and/or clear the transactions (or one or more other transactions).

In various exemplary embodiments, consumers (e.g., consumer 102, etc.) involved in the different transactions herein agree to legal terms associated with their payment accounts, for example, during enrollment in their accounts, etc. In so doing, the consumers may agree, for example, to allow merchants (e.g., merchant 104, etc.), issuers of the payment accounts, payment networks, etc., to use data collected during enrollment and/or collected in connection with processing the transactions, subsequently for one or more of the different purposes described herein (e.g., for verifying payment accounts, etc.).

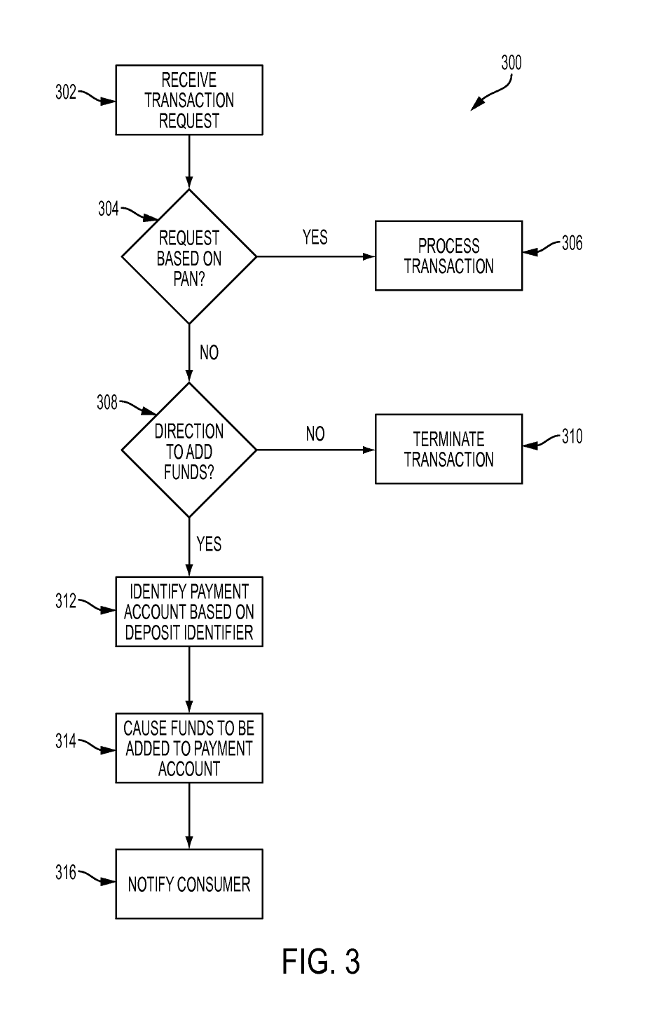

FIG. 3 illustrates exemplary method 300, for use in processing a transaction to a payment account associated with the consumer 102. The exemplary method 300 is described herein as implemented in the issuer 110 of the system 100, with it understood that the issuer 110 is capable of performing one or more of the various operations of the method 300. Further reference is also made to the consumer 102, the merchant 104, the acquirer 106, the payment network 108, and the individual 114 of the system 100. However, it should be appreciated that the method 300 could be implemented in (or in connection with) one or more other entities, in other embodiments, for example, the payment network 108, etc.

For purposes of illustration, the exemplary method 300 is also described herein with reference to the computing device 200. And, just as the method 300, and other methods herein, should not be understood to be limited to the exemplary system 100, or the exemplary computing device 200, the systems and the computing devices herein should not be understood to be limited to the exemplary method 300.

In the method 300, when a transaction occurs relating to the consumer 102, and in particular relating to the consumer's payment account, a transaction request is generated by the entity processing the transaction (as previously described in connection with system 100), and is transmitted to the payment network 108. The payment network 108 then identifies the issuer 110, from the transaction request (e.g., from the PAN or the deposit indicator in the transaction request, depending on which is included, etc.), and transmits the request to the issuer 110.

In turn, the issuer 110 receives the transaction request, at 302, as shown in FIG. 3. As described, the transaction request may relate to either a purchase transaction or a deposit transaction. When the transaction request relates to a purchase transaction at the merchant 104 (and originates from the merchant 104), the issuer 110 may receive the transaction request from the merchant 104, via the acquirer 106 and the payment network 108. Alternatively, when the transaction request relates to a deposit transaction, the issuer 110 may receive the transaction request, for example, from the individual 114 through the payment network 108 via a web interface provided by a bank associated with the individual 114. With that said, it should be appreciated that the transaction request may be received from other individuals or from other entities, or in other manners (e.g., via a phone call, a SMS message, etc.) within the scope of the present disclosure.

The transaction request includes various data (e.g., transaction data, etc.) relating to the particular transaction (as described in connection with the system 100). In addition, in method 300, when relating to a deposit transaction, the transaction request may also include various restrictions to be associated with the funds to be deposited into the consumer's payment account. Such restrictions may include, for example, the ability to spend the funds at particular merchants or on particular products, etc.

Upon receiving the transaction request, the issuer 110 determines, at 304, if the PAN for the consumer's payment account is present (e.g., detects the PAN, etc.), or if the deposit identifier for the consumer's payment account is present (e.g., detects the deposit identifier, etc.). If neither are present, or if an account identifying number (or indicator) in the transaction request is neither a PAN nor a deposit identifier, the transaction request generally will fail (by known process of detecting valid/invalid account numbers at the merchant 104, at the payment network 108, at the issuer 110, etc. (e.g., following an initial search/determination for a check digit in the transaction request, etc.)), as not including a proper payment account identifier.

With that said, in particular at 304, the issuer 110 determines if the transaction data in the transaction request includes the PAN for the consumer's payment account. This may include, for example, first determining if the transaction data includes a PAN (e.g., determining if any account identifying number (or indicator) included in the transaction data is a PAN, etc.) and, if it does not, then determining if the transaction data includes a deposit identifier (e.g., determining if any account number (or indicator) included in the transaction data is a deposit identifier, etc.) (or vice versa). In some implementations of the method, however, if the transaction data does not include a PAN (e.g., if any account identifying number (or indicator) included in the transaction data is not a PAN, etc.), the issuer 110 may simply assume that the deposit identifier is present (e.g., that any account identifying number (or indicator) included in the transaction data is the deposit identifier, etc.) (or vice versa).

The issuer 110 may distinguish the PAN from the deposit identifier in the transaction request (or simply identify the PAN and/or the deposit identifier in the transaction request), at 304, in a number of manners. For example, the issuer 110 may distinguish between the PAN and the deposit identifier based on format (or use the format to identify the PAN and/or the deposit identifier), where the PAN and the deposit identifier may have different formats (e.g., a 16-digit format for the PAN versus a 19-digit format for the deposit identifier, a numeric format for the PAN verses an alpha-numeric format for the deposit identifier, etc.). Or, the issuer 110 may identify a particular indicator in the transaction request (e.g., within the ISO message relating to the transaction request, etc.) classifying the request as relating to either a purchase transaction or a deposit transaction and indicating that any corresponding number included in the request is either the PAN or the deposit identifier. This may be implemented, for example, where the PAN and the deposit identifier include the same format. Still further, the issuer 110 may look-up an account number (or identifier) contained in the transaction request in a PAN directory in memory 204 of the computing device 200 associated with the issuer 110 (or in a deposit identifier directory in memory 204), to determine if it is a PAN or a deposit identifier. Various other mechanisms and/or differences between PANs and deposit identifiers may be used to permit the issuer 110 (or another entity) to distinguish (or simply identify) the two in transaction requests.

With continued reference to FIG. 3, when the transaction request includes the PAN, at 304, the issuer 110 identifies the corresponding payment account and processes the transaction, at 306, as a conventional transaction request (regardless of whether the transaction request relates to a purchase transaction or a deposit transaction). Simply, because the transaction request includes the PAN, it is not necessary to further determine if the transaction is a debit transaction or a deposit transaction, since the PAN can be used in connection with either type of transaction.

Alternatively, when the transaction request does not include the PAN, at 304 (i.e., it includes a deposit identifier instead), the issuer 110 determines, at 308, if the transaction request is an attempt to add funds to the consumer's payment account. In particular, the issuer 110 determines if the transaction request includes a direction or instruction, or other indicator or request, to deposit funds into the consumer's payment account. If the issuer 110 further determines that the transaction request is for some other purpose, for example, a purchase transaction (or other debit transaction), at 308, the issuer 110 terminates the transaction (e.g., declines the transaction request, causes the transaction request to be declined, etc.), at 310. As previously described, the deposit identifier allows funds to be transmitted in only one direction, i.e., deposited into the consumer's payment account, as opposed to the PAN which allows funds to be transmitted in two directions, i.e., either into our out of the consumer's payment account. As such, this operation of the method 300 helps provide a level of security to the consumer 102 when providing the deposit identifier to the individual 114 (as opposed to the PAN), for deposit transactions, because the individual 114 is limited to making deposits to the consumer's payment account (and cannot make withdrawals).

When the issuer 110 determines, at 308, that the transaction request is for adding funds to the consumer's payment account, the issuer 110 uses the deposit identifier to identify the consumer's payment account at 312 (e.g., as part of processing the transaction request, etc.). As an example, the issuer 110 may translate the deposit identifier to the PAN, so that the consumer's payment account can be identified, using an algorithm or other relationship-based formula tying the deposit identifier to the PAN. Or, the issuer 110 may simply look-up the PAN, or the payment account, using a correlation table stored, for example, in the data structure 116.

Generally in the method 300, the issuer assigns both the PAN and the deposit identifier to the consumer's payment account. As such, identifying the consumer's payment account based on the deposit identifier, at 312, will typically be done by the issuer 110 internally or independent of other entities, for example, in the system 100.

However, it should be appreciated that in other embodiments, other entities (e.g., in the system 100, or not, etc.), other than the issuer 110, may assign one or more of the PAN and the deposit identifier to the consumer's payment account. For example, in one of these embodiments, the issuer 110 assigns the PAN to the consumer's payment account while the payment network 108 assigns the deposit identifier. In this embodiment, the issuer 110 and the payment network 108 then work together to correlate the PAN and the deposit identifier, so that the correlation is available to the issuer 110 when the issuer 110 operates to identify the consumer's payment account, at 312. For example, after being assigned, the payment network 108 may transmit the deposit identifier to the issuer 110 so that the issuer 110 can store the deposit identifier in the data structure 116 in connection with the consumer's payment account. Or, in connection with identifying the deposit identifier in a transaction request, at 312, the issuer 110 may transmit the deposit identifier to the payment network 108 for identification of the corresponding PAN and, thus, the corresponding payment account. In any case, when the PAN and the deposit identifier are assigned by different entities, the different entities communicate in some manner to correlate the PAN and the deposit identifier with the consumer's payment account for use as described herein.

Then, at 314, in the method 300, the issuer 110 adds the funds to the consumer's payment account and adjusts the balance (or credit) of the consumer's payment account accordingly (e.g., as part of processing the transaction request, etc.). In some aspects of the method 300, prior to adding the funds to the consumer's payment account, the issuer 110 may initially verify a source of the funds to be added to the payment account (e.g., at an issuing bank associated with the individual 114, via the payment network 108, etc.) and settle the transaction request with the source of the funds. And, at 316, the issuer 110 notifies the consumer 102 that the addition of funds has been effected (e.g., depending on the consumer's notification preferences in the user profile, etc.).

While the system 100 and method 300 are described in connection with a deposit from the individual 114 to the consumer 102 (i.e., to the consumer's payment account), it should be appreciated that the system 100 and method 300 may facilitate deposits to the consumer 102 from other entities (e.g., online survey companies offering cash to the consumer 102 to take a survey, restaurants offering discounts or other deals to the consumer 102, merchants offering gift registries to the consumer 102, employers, etc.).

In one example implementation of the systems and methods herein, Sally wants to see a sold-out concert in California, and finds tickets for sale from Billy in New York. However, Billy will not send the tickets to Sally until payment is received. Traditional payment options are not available or desirable to Sally or Billy (e.g., Sally and Billy are too far apart for a cash exchange, not enough time is available for a bank check or money order, Billy is unwilling to provide a PAN for his bank account to Sally, Billy is unwilling to register at PayPal® or for other similar services, Billy is unwilling to visit a Western Union branch, etc.). As a solution, and through the systems and methods herein, Billy elects to provide a deposit identifier for his bank account to Sally to facilitate payment for the tickets. In response, Sally accesses a bill-pay interface, provided by her bank (either directly, or through an application program interface call to Billy's bank), that allows her to enter the deposit identifier and effect payment for the tickets. Sally's bank then transmits the payment details to the payment network 108, which in turn identifies that the deposit identifier belongs to an account issued by Billy's bank. The payment network 108 transmits the payment details to Billy's bank, who then verifies Billy's account information and approves the transaction (e.g., in accordance with the operations described in method 300, etc.). The payment network 108 clears/settles the transaction and funds are transmitted to Billy's payment account. Once Billy verifies that the funds have been transferred, he sends the tickets to Sally.

Again, and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein (e.g., in the claims, etc.).

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the methods steps herein.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. As used herein, the term “and/or” includes any and all combinations of one or more of the associated listed items.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method of processing a transaction to a payment account to add funds to the payment account, the method comprising:
receiving, at a computing device, a transaction request for a transaction to a payment account, the transaction request including a deposit identifier associated with the payment account, the transaction request not including a primary account number (PAN) for the payment account;
causing the transaction request to be processed when the transaction request includes a request to add funds to the payment account; and
causing the transaction request to be declined when the transaction request includes a request to debit funds from the payment account.

2. The method of claim 1, wherein the deposit identifier is based on the PAN for the payment account, such that said deposit identifier is convertible to the PAN through use of an algorithm and/or said PAN is convertible to the deposit identifier through use of an algorithm.

3. The method of claim 2, further comprising detecting the deposit identifier; and
translating the deposit identifier to the PAN, by the algorithm, prior to causing the transaction request be processed.

4. The method of claim 2, further comprising assigning the PAN and the deposit identifier to the payment account.

5. The method of claim 1, wherein the deposit identifier is not based on the PAN for the payment account.

6. The method of claim 1, further comprising identifying the payment account, from a plurality of different payment accounts, based on the deposit identifier.

7. The method of claim 1, wherein a format of the deposit identifier is different from a format of the PAN.

8. The method of claim 1, wherein causing the transaction request to be processed includes adding the funds to the payment account.

9. The method of claim 1, wherein causing the transaction request to be processed includes transmitting the transaction request to an issuer bank associated with the payment account.

10. The method of claim 1, wherein causing the transaction request to be processed includes:
verifying a source of the funds to be added to the payment account;
settling the transaction with the source of the funds; and
altering a balance of the payment account to include the funds added through the transaction request.

11. The method of claim 10, further comprising transmitting a notification to a consumer associated with the payment account when the balance of the payment account is altered to include the funds added through the transaction request.

12. A computer-readable storage media including computer-executable instructions that, when executed by at least one processor, cause the at least one processor to:
receive a transaction request for a transaction to a payment account, the payment account associated with a primary account number (PAN) and a deposit identifier different from the PAN, the deposit identifier capable of only allowing funds to be added to the payment account;
cause the transaction to be processed when the transaction request includes both a direction to add funds to the payment account and the deposit identifier for the payment account;
cause the transaction to be declined when the transaction request includes both a direction to debit funds from the payment account and the deposit identifier for the payment account; and
cause the transaction to be processed when the transaction request includes a direction to add funds to and/or debit funds from the payment account and also includes the PAN for the payment account.

13. The computer-readable storage media of claim 12, wherein the deposit identifier is not based on the PAN for the payment account.

14. The computer-readable storage media of claim 12, wherein the deposit identifier is based on the PAN for the payment account, such that said deposit identifier is convertible to the PAN through use of an algorithm and/or said PAN is convertible to the deposit identifier through use of an algorithm.

15. The computer-readable storage media of claim 12, wherein the deposit identifier and the PAN include different formats.

16. The computer-readable storage media of claim 12, wherein when executed by the at least one processor, the computer-executable instructions further cause the at least one processor to assign the PAN and the deposit identifier to the payment account.

17. The computer-readable storage media of claim 12, wherein when executed by the at least one processor, the computer-executable instructions further cause the at least one processor to transmit a notification to a consumer associated with the payment account when funds, identified in the transaction request, are added to the payment account.

18. A computer-implemented method of processing a transaction to a payment account to add funds to the payment account, the method comprising assigning, by a computing device, a deposit identifier to the payment account, the deposit identifier suitable for use only to add funds to the payment account and not to debit funds from the payment account.

19. The method of claim 18, further comprising assigning the deposit identifier to the payment account based on a primary account number (PAN) of the payment account, so that the PAN can subsequently be determined based on the deposit identifier.

20. The method of claim 18, further comprising assigning the deposit identifier to the payment account independent of the primary account number of the payment account.
